(19) United States
(12) Patent Application Publication
(10) Pub. No.: US 2010/0215458 A1
(43) Pub. Date: Aug. 26, 2010

(54) FASTENER RETENTION ANCHOR

(76) Inventor: DEREK LEE CUSHMAN, Greenville, MI (US)

Correspondence Address: KANE & CO., PLC, 29 PEARL ST. NW, 410 FEDERAL SQUARE BUILDING, GRAND RAPIDS, MI, 49503, US

(21) Appl. No.: 12/773,178

(22) Filed: May 4, 2010

Related U.S. Application Data
(63) Continuation-in-part of application No. 11/654,069, filed on Jan. 17, 2007.

(51) Int. Cl. F16B 39/00

(52) U.S. Cl. 411/107

(57) ABSTRACT

An anchor is provided for use in assembling components. The anchor includes a body portion including an aperture and a barrier disposed within the aperture. Extending from the first surface of the body is a retention member with a plurality of sidewalls and at least one locking tab. Extending from a second surface of the body is at least one snap flange which retains a stiffener plate containing an offset and a hole in alignment with the anchor's aperture.

### CROSS REFERENCE TO RELATED APPLICATION

This is a continuation-in-part application of a co-pending U.S. patent application Ser. No. 11/654,069 filed on Jan. 17, 2007 the contents of which are incorporated herein by reference.

### BACKGROUND OF THE INVENTION

1. Field of the Invention

The present invention generally relates to a fastener, more specifically a retention anchor and particularly to a fastener retention anchor assembly for fastening various parts/components to a decorative substrate such as an appliance interior.

2. Description of the Related Art

In the past product manufacturers have relied upon metal stampings to serve as anchors to receive and retain conventional fasteners. One particular application of these anchors involves retaining fasteners to an appliance liner such as a refrigerator. In this particular application expansion foam is oftentimes applied inside the appliance to insulate the liner. The metal stampings by themselves are unable to seal the liner allowing the foam to contaminate the product. One prior art solution to this issue was to seal the holes and anchor the metal stamping with two-sided tape.

Two-sided tape however presents its own problems. Two-sided tape includes and requires the removal and disposal of a backing or release paper by the assembly operator prior to the metal anchor being affixed to the substrate. Further, once the release paper is removed from the tape, the adhesive becomes free to adhere to any nearby surface and requires special handling by the operator. Other quality issues relating to two-sided tape include: parts being taped to the wrong locations, dropped parts sticking to the floor, and parts failing to adhere to the liner.

These issues can be minimized or eliminated by the use of a new fastener retention anchor design described below.

### SUMMARY OF THE INVENTION

An anchor is provided for use in assembling components. The anchor includes a body portion including an aperture and a barrier disposed within the aperture.

In another form of the invention, an anchor is provided for use in assembling components. The anchor includes a body portion including an aperture and a barrier disposed within the aperture. Extending from the first surface of the body is a retention member with a plurality of sidewalls and at least one locking tab. Adjacent to a second surface is a stiffener plate.

In still another form of the invention, an anchor is provided for use in assembling components. The anchor includes a body portion including an aperture and a barrier disposed within the aperture. Extending from the first surface of the body is a retention member with a plurality of sidewalls and at least one locking tab. Extending from a second surface of the body is at least one snap flange which retains a stiffener plate containing an offset and a hole in alignment with the anchor's aperture.

### BRIEF DESCRIPTION OF THE DRAWING FIGURES

Other advantages of the present invention will be readily appreciated as the same becomes better understood by reference to the following detailed description when considered in connection with the accompanying drawings wherein:

FIG. 1 is a schematic view of a component.

FIG. 2 is a cross sectional view of a fastener retention anchor taken at section A-A in FIG. 1.

FIG. 3 is an exploded view of a fastener retention anchor assembly.

FIG. 4 is a cross sectional view of an alternate embodiment of a fastener retention anchor taken at section B-B in FIG. 1.

FIG. 5 is an exploded view of the alternate embodiment fastener retention anchor including a stiffener plate, a substrate with hole, a mounted attachment and a fastener.

FIG. 6 is an exploded view of a fastener retention anchor with rounded retention surface and a substrate with a rounded hole.

FIG. 7 is an exploded view of a fastener retention anchor including stakes and a stiffener plate.

FIG. 8 is an exploded view of a fastener retention anchor with a clear face area and a stiffener plate.

FIG. 9 is an oblique view of a fastener retention anchor assembled to a flat stiffener plate.

FIG. 10 is an oblique view of a fastener retention anchor including an overmolded stiffener plate.

### DESCRIPTION OF THE DIFFERENT EMBODIMENTS

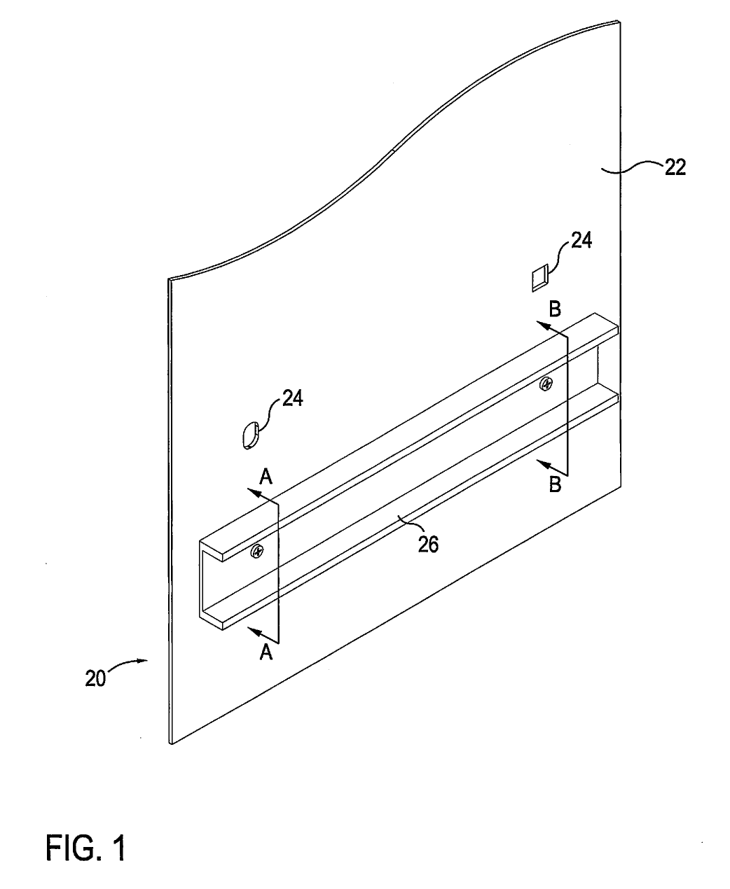

For purposes of the following description, the terms “upper,” “lower,” “left,” “rear,” “front,” “vertical,” “horizontal” and derivatives of such terms shall relate to the invention as oriented in FIG. 1. However, it is to be understood that the invention may assume various alternative orientations and configuration, except where expressly specified to the contrary. It is also to be understood that the devices and processes illustrated in the attached drawings, and described in the following specification are simply exemplary embodiments of the inventive concepts defined in the inventive concepts of this invention. Specific dimensions and other physical characteristics relating to the embodiments disclosed herein are not to be considered as limiting unless expressly stated otherwise.

A generic component 20 capable of receiving a fastener anchor is shown in FIG. 1. The component 20 includes a substrate 22 having a plurality of holes 24 located at various locations throughout the substrate 22 for mounting various attachments 26. Holes 24 may have a range of sizes and shapes, including squares or rectangles to prevent an anchor from rotating when a fastener is inserted.

Anchor 28 includes a base or body component 30 comprised of a first face 32, sized to be larger than hole 24 in at least one direction or dimension and a second opposite face 34 offset from and preferably parallel to the first face 32. Walls 36 connect the peripheral edges of the first and second faces 32, 34 enclosing the base or body component 30. The embodiment shown in FIG. 3 depicts the base or body component 30 as a rectangular shape which extends beyond all edges of the substrate's hole 24 completely sealing the opening.

Extending from the base component's first face 32, preferably at a perpendicular angle, is an optional positive relief called a retention member 38. This positive relief includes a plurality of side walls 40 which terminate into a third face 42 preferably parallel with first face 32. The shape of the positive relief may be of any shape capable of passing through hole 24 in substrate 22, and preferably is similar in shape to hole 24. The height of the retention member 38 may be of any height sufficient to engage and retain the anchor 28 to the substrate 22, but is preferably sized to match the thickness of the substrate itself so that the third face 42 lies flush with the substrate 22 once installed.

Optionally the side walls 40 of the optional retention member 38 may include a plurality of draft angles relative to the insertion direction of the anchor 28 into the substrate 22. Positive draft angles 44 applied to the retention member 38 facilitate insertion of the anchor 28 into the substrate 22 and negative draft angles 46 resist removal of the anchor 28 once inserted into the substrate 22. A combination of both positive and negative draft angles 44, 46 is shown in FIG. 3. In this instance, the positively drafted 44 side wall 40 assists with the initial assembly of the anchor to the substrate 22, while the negatively drafted 46 side wall 40 retains the anchor 28.

A plurality of apertures 48 are then placed into the anchor's first face 32 or into optional retention member's 42 third face. These apertures 48 are preferably centered on and are oriented perpendicular to the face. The aperture 48 may be conical, cylindrical or any other shape suitable to retain a fastener and may be made of any depth, including a thru hole. The aperture 48 may additionally include a barrier of material 50 to prevent material from passing through the anchor 28. This barrier 50 may be located anywhere along the aperture 48, and may be of any thickness which is capable of sealing the aperture 48, including what is known in the art as ‘flash’.

Optionally, a second positive relief called an operator assembly tab 52 may be added, preferably to the second face 34. This assembly tab 52 allows an assembly operator to grasp and manipulate the anchor 28 during assembly to the substrate 22. The assembly tab 52 may double as an injection molding gate for the part and may be geometrically sized, shaped or colored as necessary.

The anchor 28 itself is preferably constructed of a material similar to that of the substrate 22; however the invention may be practiced with many various materials, including ferrous and non ferrous metals, plastics or any combination thereof.

The fasteners 54 used with the invention may include screws, rivets, bolts, pins, rods, nails, ‘Christmas trees’, bushings, stakes, interlocks or other articles commonly known in the art for joining components. The fasteners 54 may be made of any suitable structural material known in the art. While a screw is shown in the preceding figures, this is by way of illustration only, and is in no way limiting.

### First Embodiment

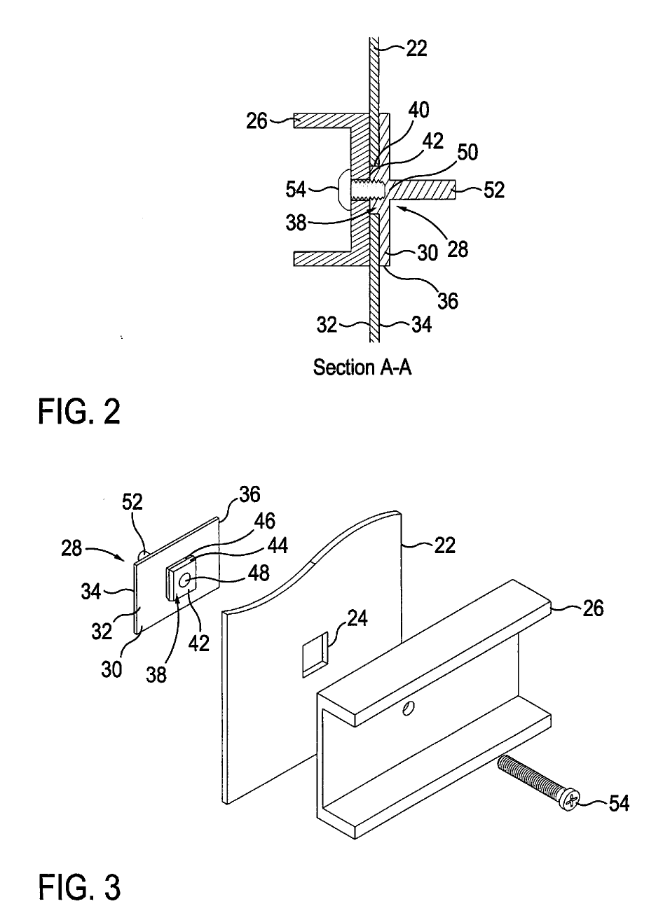

The first embodiment of a fastener retention anchor 28 is shown in FIGS. 2 and 3 and modifies side walls 40 on the retention member 38 so that they create an interference or press fit with the substrate when inserted into hole 24. In this embodiment optional positive draft angles 44 or negative draft angles 46 on the retention member's side walls 40 may be further adapted to assist the insertion and retention of the anchor to the substrate.

### Second Embodiment

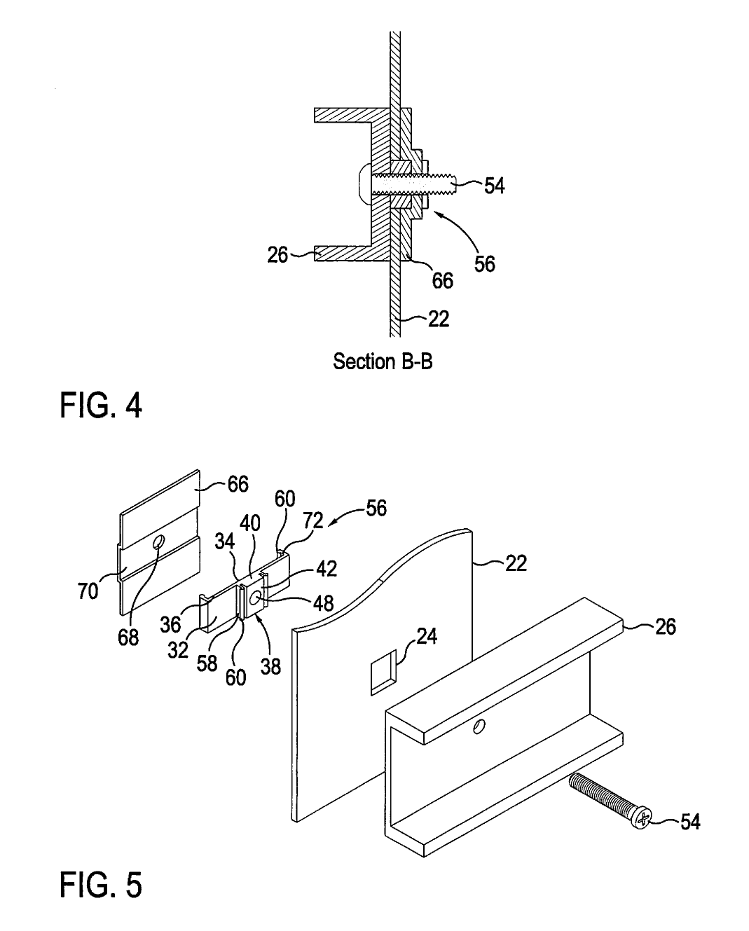

Another embodiment of the invention is shown in FIGS. 4 and 5, and depicts a fastener retention anchor 54 including a snap lock retention member. For the purposes of brevity and clarity, only those portions of the anchor that are different from that described above will be described.

The previously mentioned embodiment (FIGS. 2-3) uses a press or interference fit between the retention member and the substrate hole to retain the anchor. In order for anchor to achieve this fit, the dimensions between the side walls 40 and the substrate hole 24 are typically held to a tolerance. This tolerance controls the variation within the fit: too much interference and the anchor will not be able to be placed into the substrate's hole 24; too little interference and the anchor may become dislodged during the assembly process. Maintaining an acceptable fit tolerance in a manufacturing environment can be costly endeavor, thus a lower cost solution with larger acceptable assembly tolerance was envisioned.

Anchor 28 in FIGS. 2 and 3 is modified by sizing the retention member 38 smaller than the substrate's hole 24 creating anchor 56. This modification removes the ability to form a press or interference fit, and preferably creates a clearance or free running fit. Anchor 28 is further modified by adding a plurality of locking tabs 58 including locking features 60, which are spaced separately from the retention member 38. These locking features 60 may be any feature adapted to engage the substrate's hole 24 and may include a plurality of inclined planes. A fastener retention anchor including a snap lock retention member is shown generally at 56.

The locking tabs 58 are ideally constructed such that they may easily deform under a compressive load perpendicular to the axis of assembly and then return to their original location when the compressive load is removed. One embodiment of the locking tab 58 is constructed of a slender rectangular shape which may easily deform under the compression load generated by inserting an anchor 56 through the substrate hole 24. The compressive forces deflect the locking tab 58, thereby allowing the locking feature 60 to engage hole 24. Once inserted into the hole 24, the locking feature 60 then returns to its original undeformed position engaging the substrate 22 and retaining the anchor 56. This locking tab retention member 58 allows for the use of larger tolerances between the size of the anchor 56 and the substrate's hole 24.

Additional benefits of the snap locking design include the ability to center the anchor's aperture 48 on an off centered mounted attachment 62 (not shown). As a fastener 54 is inserted through an off-centered attachment 62 the fastener 54 will come to rest against the off-centered attachment's aperture or mounting hole 64 (not shown) and press against only one side of the anchor's fastener aperture 48. As the fastener 54 is further inserted, lateral loads are generated on the fastener aperture 48 by the fastener 54 creating a lateral load upon the locking tabs 58. This lateral force repositions the anchor 56 within the substrate's hole 24, centering the fastener aperture 48 on the off centered attachment's mounting hole 64 bringing them into alignment.

The ability to accept a larger dimensional tolerance between the anchor 54 and the hole in the substrate 24 in combination with the ability to reposition the aperture 48 to co-align with various attachments 26 represents improvements over the press fit retention design. A further benefit of the locking tab design is that the locking features 60 engages a greater area of the substrate's hole 24 when assembled thereby providing a better retention method as compared to alternate designs.

### Third Embodiment of the Invention

An alternate embodiment of anchor 28 shown in FIGS. 2 and 3 may optionally include a stiffener plate 66 reinforcing the base component 30. For the purposes of brevity and clarity, only those portions of the anchor that are different from that described above will be described.

The previously mentioned anchor 28 includes base component 30, a feature which assists in sealing the substrate hole 24 and also which prevents the anchor 28 from passing through the substrate 22. While this design is acceptable for most applications, some alternate applications require additional strength or rigidity beyond which the standard base component 30 alone can normally support. One solution to this issue is to add a stiffener plate 66 to the design. This stiffener plate 66 reduces the amount of material required in the base component 30 and further assists the anchor 28 by supporting some of the fastener's 54 load.

One embodiment of a stiffener plate 66 is shown in FIGS. 4 and 5 and includes an optional stiffener plate hole 68. In this embodiment the centerline of the fastener aperture 48 co-aligns with the centerline of the stiffener plate's hole 68. This allows the stiffener plate's hole 68 to receive a fastener 54 during assembly allowing the stiffener plate 66 to assist with fastener load distribution. Additionally, the stiffener plate's hole 68 assists in retaining the fastener 54 to the anchor.

The stiffener plate 66 is typically constructed from rigid materials. These may include glass reinforced resins, plastics, or metals. Steel is one preferred material due to its strength and rigidity in this application. The shape and thickness of the stiffener plate 66 is derived from the loads applied upon the fastener 54 and the structural loading limitations of the substrate 22. Ideally the dimensions of the stiffener plate 66 are chosen so that the substrate 22 does not visibly deform when the fastener 54 is fully loaded. One such stiffener plate design is shown in FIGS. 4 and 5.

Additional features such as a stiffener plate offset 70 may be added to the design to accommodate the material thickness of the anchor 28 to which it is attached, thereby allowing the stiffener plate 66 to sit flush with the substrate 22. This flush fit better distributes load to the substrate 22 while simultaneously covering the holes 24 therein.

The stiffener plate 66 may be retained to an anchor in many various ways, one example of which is shown in FIGS. 4 and 5. This embodiment of the anchor 56 uses a plurality of stiffener plate snap lock tabs 72, also referred to as snap flanges, include locking features 60 to retain the plate 66. These locking tabs 72 are constructed by creating a plurality of positive reliefs on the second face 34 of the base component 30. The shape and function of the stiffener plate snap lock tabs 72 are similar to the locking tabs 58 described earlier and are designed to engage and retain the stiffener plate 66.

Assembly occurs by pressing the stiffener plate 66 past the snap lock's 72 locking feature 60 until the plate 66 is retained by the anchor 56. Ideally when assembled the stiffener plate 66 will lay flush against the second face 34. Optional operator assembly tab 52 may need to be removed or reoriented to a new location so that it does not interfere with the function of the stiffener plate 66.

### Fourth Embodiment of the Invention

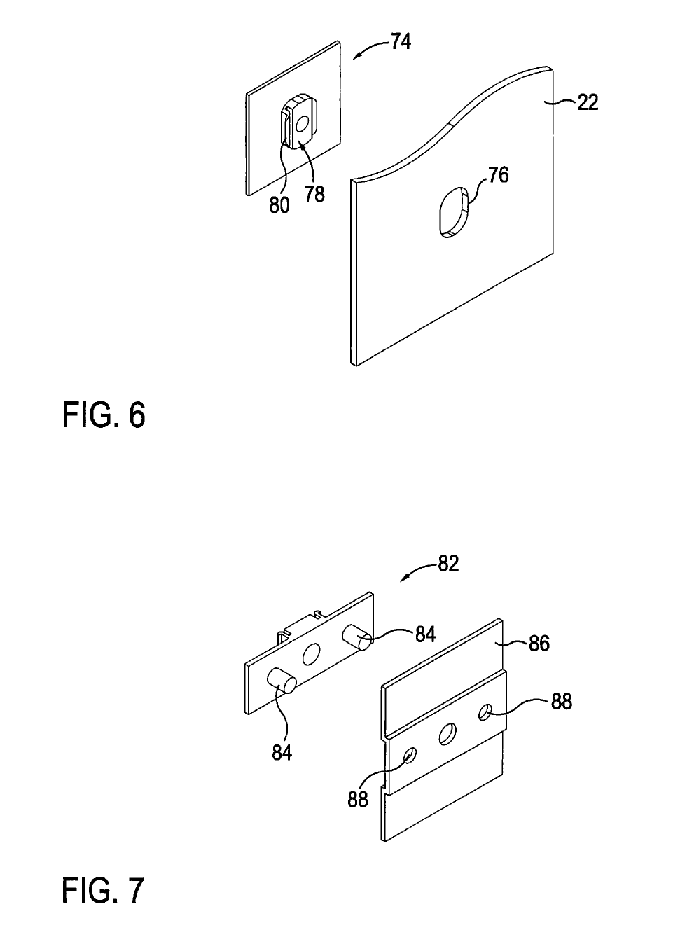

A further alternate embodiment of anchor 74 is shown in FIG. 6. For the purposes of brevity and clarity, only those portions of the anchor that are different from that described above will be described.

The previously mentioned anchors showed in FIGS. 2-5 depicted retention members 38 which were rectangular in shape. Rectangular shapes naturally include sharp corners, which are known in the art to be prone to stress risers and crack nucleation. Circular shapes, on the other hand are excellent at resisting crack nucleation but are also typically poor candidates for anchors due to their propensity to rotate freely when torque is applied. One solution to the cracking and rotation dilemma is to use a rounded substrate hole 76 that includes rounded surfaces combined with a plurality of straight walls or other similar anti-rotation features.

An embodiment of an anchor 74 including a rounded retention region 78 adapted to mate with the rounded substrate hole 76 is shown in FIG. 6. This rounded anchor 74 may include interference fit side walls 40 or may use the snap lock style of retention discussed previously. The rounded anchor 74 may also include the optional stiffener plate 66 if so desired.

A rounded anchor 74 is created by rounding off the side walls of the aforementioned retention member creating a rounded retention member 78 which is preferably similar in profile to the rounded substrate's hole 76. The locking tabs 58, if utilized, are narrowed to meet the new rounded profile creating narrowed snap lock tab 80 similar to those shown in FIG. 6. The rounded anchor 74 otherwise performs similarly to the rectangular snap lock anchor described above.

### Fifth Embodiment of the Invention

A still further alternate embodiment of anchor 82 is shown in FIG. 7. In this embodiment, the previously mentioned stiffener plate snap lock tabs 72 are replaced by a plurality of retention stakes 84 creating a part that can not be disassembled without destruction of the anchor itself. For the purposes of brevity and clarity, only those portions of the anchor that are different from that described above will be described.

The embodiment of the anchor with stiffener plate snap lock tabs 72 shown in FIGS. 4 and 5 is modified by removing the stiffener plate snap lock tabs 72 and in its place, adding a plurality of positive reliefs to its second face. This new anchor, shown generally at 82, includes positive reliefs, called retention stakes 84, which extend from the anchor 82 a distance sufficient to engage a modified stiffener plate.

The modified stiffener plate 86 includes additional apertures 88 located at corresponding locations to the stakes 84 of anchor 82. The apertures 88 will preferably include the same cross sectional shape and a slightly larger profile than the retention stakes 84, in order to receive the stakes 84 through the apertures 88.

Assembly is accomplished by aligning the retention stakes 84 on anchor 82 so that the staking apertures 88 and stakes 84 co-align. The stakes 84 are then passed through the apertures 88 until the stiffener plate with additional apertures 86 rests against the staked anchor 82. The tips of stakes 84 are then deformed though application of heat, pressure, vibration, or the like such that the stakes 84 either melt or deform. The deformed stakes tips retain the plate 86 to the anchor 82. This assembly may then be used as mentioned in the above applications.

An alternate embodiment of the staked anchor 82 utilizes a plurality of retention stakes 84 with locking features on their heads. This locking stake (not shown) is created by placing a snap lock retention feature 60 onto a plurality of stakes 84. Assembly is then is accomplished placing the stake with retention feature through the plate's aperture 88 such that the snap lock retention feature 60 engages the plate 86.

### Sixth Embodiment of the Invention

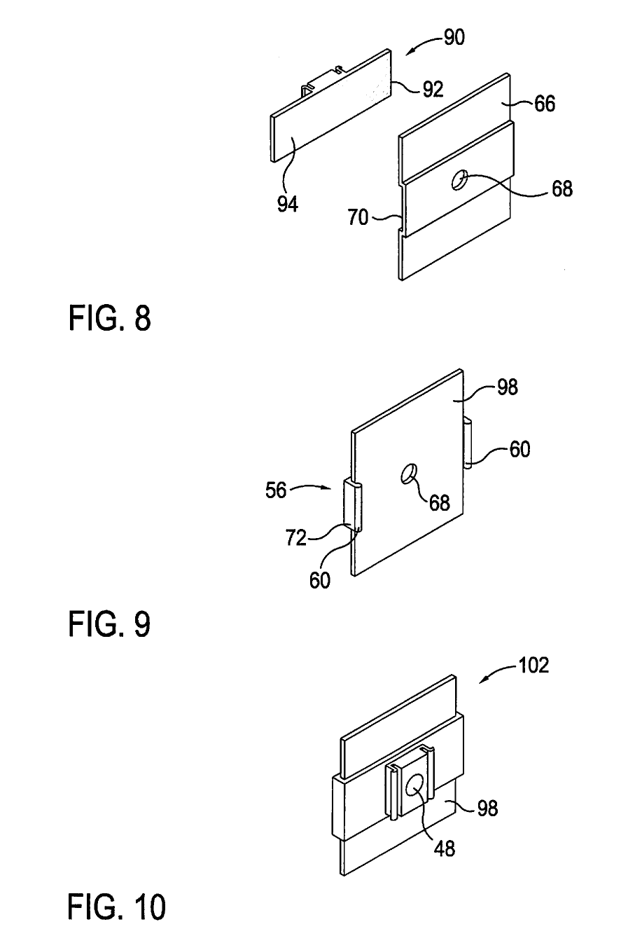

Another embodiment of the anchor 90 is shown in FIG. 8. For the purposes of brevity and clarity, only those portions of the anchor that are different from that described above will be described.

This embodiment includes a second face 92 with an area free from features. In this embodiment, the clear face area 92 receives an adhesive placed into an adhesive zone 94 indicated by hashed lines. A stiffener plate 66 is then positioned such that its optional hole 68 (if present) is co-aligned with the centerline of the fastener aperture 48. The stiffener plate 66 is then placed into contact with the second face 92 of the anchor 90 until the adhesive bonds the parts together. This creates an adhesed fastener anchor assembly (not shown). The anchor assembly is then handled as described in the sections above.

### Seventh Embodiment of the Invention

An further embodiment of anchor 96 is shown in FIG. 9 and includes a flat stiffener plate 98. For the purposes of brevity and clarity, only those portions of the anchor that are different from that described above will be described.

An additional embodiment of the stiffener plate 98, is shown in FIG. 9 and utilizes a flat stamping which may include an optional hole 100. This embodiment is simpler to form and process. The flat stiffener plate 98 functions similar to a stiffener plate with offset 66 shown in FIGS. 4 and 5 and described earlier.

### Eighth Embodiment of the Invention

A still further alternate embodiment of the anchor 102 is shown in FIG. 10. For the purposes of brevity and clarity, only those portions of the anchor that are different from that described above will be described.

In this embodiment, the flat stiffener plate 98 shown in FIG. 9 and described earlier is inserted into the mold during the forming operation creating a new integral anchor 102. This embodiment is unable to be disassembled once formed, preventing the stiffener plate 98 from becoming dislodged or lost during the assembly process. The anchor with over molded stiffener plate 102 functions in a manner similar to others described above.

Modifications of the invention will occur to those skilled in the art and to those who make or use the invention. Therefore, it is understood that the embodiments shown in the drawings and described above are merely for illustrative purposes and not intended to limit the scope of the invention.

1. An anchor comprising:
a body;
an aperture extending through said body; and
a barrier disposed within said aperture.

2. The anchor as defined in claim 1, wherein said body further comprises a retention member extending from a first surface of said body to form a plurality of sidewalls.

3. The anchor as defined in claim 1, further comprising a stiffener plate disposed adjacent a second surface of said anchor body.

4. The anchor as defined in claim 1, further comprising a tab extending from a second surface for use in manipulating and positioning said anchor assembly.

5. The anchor as defined in claim 2, wherein a first portion of said sidewalls include a positive draft relative to an axis concentric with said aperture.

6. The anchor as defined in claim 2, wherein a second portion of said sidewalls include a negative draft relative to an axis concentric with said aperture.

7. The anchor as defined in claim 2, wherein said retention member further comprises at least one locking tab extending from said first surface of said anchor body

8. The anchor as defined in claim 3, wherein said stiffener plate includes a hole disposed in registered alignment with said aperture.

9. The anchor as defined in claim 3, further comprising:
at least one snap flange extending from said second surface and adapted to engage said stiffener plate and retain said stiffener plate adjacent said anchor body.

10. The anchor as defined in claim 3, wherein said anchor includes an adhesive retaining said stiffener plate.

11. The anchor as defined in claim 3 wherein said anchor includes a plurality of stakes extending from said second surface, retaining said stiffener plate adjacent said anchor body.

12. The anchor as defined in claim 3 wherein said stiffener plate is overmolded.

13. The anchor as defined in claim 3 wherein said stiffener plate includes a plurality of stiffener plate offsets.

14. The anchor as defined in claim 7, further comprising at least one snap flange extending from a second surface.

15. An anchor comprising:
a body;
an aperture extending through said body; and
a barrier disposed within said aperture;
a retention member extending from a first surface of said body to form a plurality of sidewalls;
at least one locking tab extending from said first surface of said anchor body; and
a stiffener plate disposed adjacent a second surface of said anchor body.

16. The anchor as defined in claim 15 wherein said stiffener plate includes an offset.

17. The anchor as defined in claim 15 further comprising at least one snap flange extending from said second surface and adapted to engage said stiffener plate and retain said stiffener plate adjacent said anchor body

18. The anchor as defined in claim 15 wherein said stiffener plate includes a hole disposed in registered alignment with said aperture.

19. The anchor as defined in claim 15 further comprising a tab extending from a second surface for use in manipulating and positioning said anchor assembly.

20. An anchor comprising:
a body;
an aperture extending through said body; and
a barrier disposed within said aperture;
a retention member extending from a first surface of said body to form a plurality of sidewalls;
at least one locking tab extending from said first surface of said anchor body; and
a stiffener plate disposed adjacent a second surface of said anchor body including and an offset and a hole which is disposed in registered alignment with said aperture; and
at least one snap flange extending from said second surface, retaining said stiffener plate adjacent said anchor body.
